(19) United States
(12) Patent Application Publication
(10) Pub. No.: US 2024/0301732 A1
(43) Pub. Date: Sep. 12, 2024

(54) MAGNETIC POSITIONING HINGE FOR HORIZONTAL DOOR ASSEMBLY

(71) Applicant: WINSTON INDUSTRIES, LLC, Louisville, KY (US)

(72) Inventors: Kevin Paul Combs, Louisville, KY (US); Trevor Jordan Carver, Alexandria, KY (US)

(21) Appl. No.: 18/444,686

(22) Filed: Feb. 17, 2024

Related U.S. Application Data
(63) Continuation-in-part of application No. 16/862,522, filed on Apr. 29, 2020, now Pat. No. 11,906,170.

(51) Int. Cl. E05D 11/10; E05D 3/02; E05D 5/04; E05D 9/00; F24C 15/02

(52) U.S. Cl. CPC E05D 11/105; E05D 3/02; E05D 5/046; E05D 9/00; F24C 15/026; E05Y 2900/308

(57) ABSTRACT

An integrated magnetic catch used to hold a horizontal hinged oven door open at a selected set partially open position. A pin and knuckle assembly is used to hold the two plates together and acts as a pivot point. Attached to a stationary plate is a positioning member comprising a housing containing a magnetic material. This positioning member is formed having a preset angle that correlates with the degree that the door is to be opened. When the door is opened and pivoted the first plate of the rotating hinge makes contact with the second plate of the rotating hinge having a positioning member affixed thereto and the magnetic force holds the door open at a selected angle.

### CROSS REFERENCES TO RELATED APPLICATIONS

This application claims priority from U.S. patent application Ser. No. 16/862,522 filed on Apr. 29, 2020 which claims priority from U.S. Provisional Application Ser. No. 62/840,122 filed on Apr. 29, 2019 both of which are incorporated by reference herein in their entirety.

### TECHNICAL FIELD OF THE INVENTION

This invention relates to an integrated magnetic catch used to hold a horizontal hinged oven door open at a selected angle.

### BACKGROUND OF THE INVENTION

The present invention pertains to an improved door hinge assembly for ovens and food storage cabinets and the like.

In fast food restaurants and cafeterias, food is prepared in an oven and served or maintained at a selected temperature for serving in a heated cabinet with controls for temperature and/or humidity. Typically these ovens or food service cabinets are vertical and have horizontally hinged doors which are raised upward for access. When a server selects an item for a customer, the server opens the oven or storage cabinet door with one hand and obtains the food item with the other closing the door; or simply secures the door in an open position for removal of one or more food items. Holding the door open is inconvenient and inefficient.

In order to maintain food textures after cooking, with controlled vapor holding cabinet using heated water vapor to precisely control temperatures such as are available from Winston Industries which give accurate food temperatures from 90 to 180 degrees allowing the user to adjust temperatures accordingly for proofing, holding, and serving. Propping the door open for an extended period of time can result in food drying out, cooling down and losing moisture, in addition to compromising the temperature and humidity of the food preparation apparatus.

Conventional oven door positioning hinges used on food service ovens have mechanical positioning components such as springs, notches, and latches that wear down over time. The present invention provides a positional hinge and holding means for releasibly and temporarily holding a shelf door open at a selected position out of the way of the food server.

### SUMMARY OF THE INVENTION

An integrated magnetic catch used to hold a horizontal hinged oven door open at a selected set partially open position. A pin and knuckle assembly is used to hold the two plates together and acts as a pivot point. Attached to a stationary plate or formed integrally therewith is a positioning member comprising a housing containing a magnetic material. This positioning member is formed having a preset angle that correlates with the degree that the door is to be opened. When the door is opened and pivoted the first plate of the rotating hinge makes contact with the second plate of the rotating hinge having a positioning member affixed thereto and the magnetic force holds the door open at a selected angle.

More particularly, a magnetic positioning hinge assembly utilizers an integrated magnetic catch used to hold a door open at a set position or angle. The door frame hinge for the oven, cabinet, or other device utilizes at least one and preferably a pair of metal hinge plates attaching to a segmented tube for coaxial engagement with a pin in a knuckle assembly. The present invention utilities a pair of leafs or plates, made of ferrous material or including at least some material incorporated therein or affixed thereto which is susceptible to magnetic forces. The plates extend from a segmented cylindrical shaped tube defining a knuckle to accept a pin allowing pivotal movement. This pin and knuckle assembly is used to hold the two plates together and acts as a pivot point. Attached to one of the plates is a magnetic member which is affixed thereto or housed within a positioning member. The magnetic member or positioning member holding same is formed with a preset angle in mind and acts as a stop and/or support means that correlates with the degree that the door is to be opened. When the rotating hinge makes contact with the positioning member, the magnetic force holds the door open. The hinge allows for the easy and quick access to the cabinet. The magnetic member or positioning member holding same may be formed as a wedge shaped member providing additional surface area and support to the door frame magnetic engaging same. This pin and knuckle assembly is used to hold the upper frame plate and lower door plate together and acts as a pivot point. The upper plate is attached to the stationary frame with a positioning member housing a magnet material affixed to the upper plate or if the positioning member and upper plate if formed integrally, the positioning member plate is attached to the frame of the cabinet. the lower plate is pivotally attached to the pivoting door.

The magnetic member can be formed having a preset angle that correlates with a selected degree that the door is to be held partially open at a set position whereby the rotating hinge allows the metal or magnetic surface of the door plate to contact the magnetic member so the magnetic force holds the door open until pressure is exerted pulling the door downward.

It is an object of the present invention to utilize magnets having a magnetic grade of from n35 to n52; however, an effective magnetic force to hold the door may vary according to the position of the magnet and selection of magnet housing materials.

It is an object of the present invention to provide a means for setting an angle and potential angle range for a set position for holding open a horizontal hinged door whereby the hinge can accommodate any inner angle equal to or less than 180 degrees.

It is an object of the present invention to provide a means for selecting a plastic for the magnet housing which does not shield the magnetic field of the magnet used in the hinge assembly.

It is an object of the present invention utilize acrylonitrile butadiene styrene, (“ABS”), as a plastic for the magnet housing so it does not shield the magnetic field of the plastic hinge.

It is an object of the present invention to determine an inner angle of an open hinge by the height of an open door and to minimize moment on the door.

It is an object of the present invention to provide a horizontal hinge and door assembly with a magnetic positioning hinge for use on any type of cabinet, appliance of apparatus having a horizontal hinged panel, door, or window where it is desirable to hold a window, door, or other panel open at a set position at a selected angle until the window, door, or panel is pulled downward to disengage the magnetic force holding the plates of the hinge together.

It is an object of the present invention to provide a magnetic positioning hinge whereby the angle can be set by the shape and size of a positioning member and the angle is not adjustable by the end user.

It is an object of the present invention to provide a magnetic positioning hinge whereby the angle can be set by the shape and size of an injection molded positioning member and the angle is not adjustable by the end user.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a perspective view of a food service oven showing a pair of pivoting doors for accessing a top and bottom shelf;

FIG. 2 is a front view of FIG. 1 showing upper and lower front doors;

FIG. 3 is a rear view of FIG. 1 showing upper and lower rear doors;

FIG. 4 is a left side view of FIG. 1;

FIG. 5 is a right side view of FIG. 1;

FIG. 6 is a enlarged view showing the control panel for a food service oven;

FIG. 7 is a front view of a oven cabinet door frame of FIG. 1 having a top and bottom pivoting door;

FIG. 8 is a side view of the door frame and hinge assembly of FIG. 1;

FIG. 9 is a sectional side view of the hinge showing the door panel frame and hinge assembly of FIG. 1;

FIG. 10 is a rear view showing a rear oven door frame with a magnetic material disposed in plastic housing affixed thereto of FIG. 1.

FIG. 11 is a sectional view showing the oven panel frame plate showing a magnetic positioning member shaped as a wedge containing a magnetic material attached to an upper plate of the hinge and a magnetic holding member mounted on the opposing side of the door frame member opposite from and in alignment with the lower plate of the hinge;

FIG. 12 is an exploded perspective view of the door assembly of the over shown in FIG. 1;

FIG. 13 is a perspective view of the oven door frame and hinge assembly and the projecting magnetic holding member having a wedge shaped projection for holding an oven door at a selected angle;

FIG. 14 is a front view of a hinge showing the plates held by a pin (not shown) disposed in the segmented tube forming the knuckle of the door and frame assembly;

FIG. 15 is a top perspective view showing a top of the door frame and hinge assembly;

FIG. 16 is a perspective view of the door frame and hinge assembly and the projecting magnetic positioning member comprising a wedge shaped housing affixed to the upper plate for supporting an oven door open at a selected angle and showing the lower door hinge plate for cooperative magnetic engagement with the magnetic positioning member;

FIG. 17 is a side view of the oven door frame and hinge assembly of FIG. 16, showing the knuckle and pin positioned below the upper plate and above the lower plate; and

FIG. 18 is a side view of the oven door frame and hinge assembly and the projecting magnetic positioning member comprising a wedge shaped housing holding a door in an open upward position at a selected angle with the lower plate resting against the magnetic positioning member cooperative magnetic engagement.

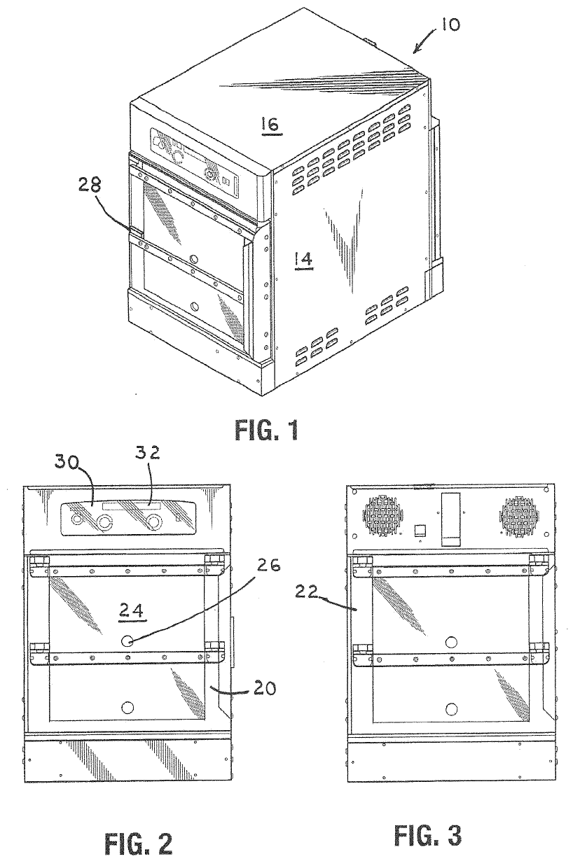

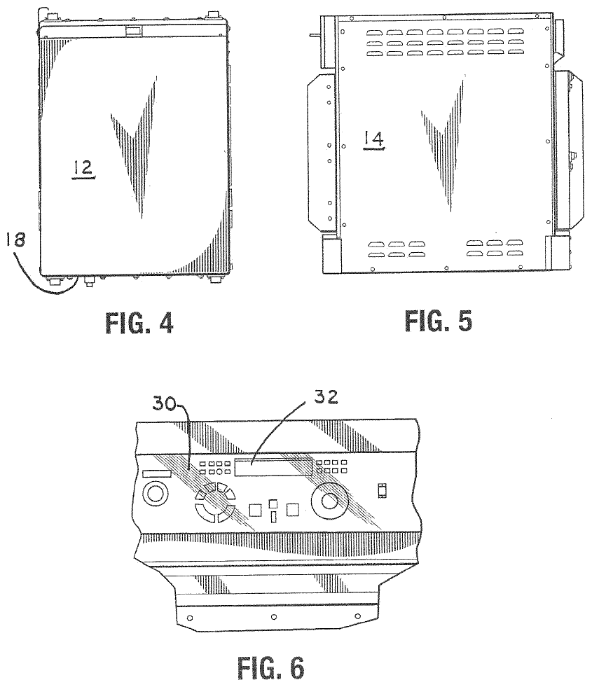

### DETAILED DESCRIPTION OF THE PREFERRED EMBODIMENT

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “about” can be reasonably appreciated by a person skilled in the art to denote somewhat above or somewhat below the stated numerical value, to within a range of +10%.

The information included in this section, data or specifications, including any references cited herein and any description or discussion thereof, is included for exemplary purpose only and is not to be regarded as subject matter by which the scope of the invention as defined in the claims appended hereto is to be bound.

The following text sets forth a broad description of numerous different embodiments of present disclosure. The description is to be constructed as exemplary only and dose not describes every possible embodiment since describing every possible embodiment would be impractical if not impossible. It will be understood that any feature, characteristic, component, composition, ingredient, product, step or methodology described herein can be deleted, combined with or substituted for, in whole or part, any other feature, characteristic, composition, ingredient, product, step or methodology described herein. Numerous alternative embodiments could be implemented, using either current technology or technology developed after the disclosure date of the invention.

The description of the exemplary embodiments according to principles or spirits of the present invention is intended to be read in connection with the accompanying drawings, which are to be regarded as part of the entire written description. In the description of the embodiments of the invention disclosed herein, for describing precisely and concisely, each element in the drawings is assigned a reference number in most cases in term of its feature corresponding the claims append unless expressly described otherwise, e.g., if a valve is claimed, no matter the valve is a ball valve, a membrane valve, or poppet valve in an exemplary embodiment, the valve members or valve seats in different drawings are assigned one element reference number unless expressly described otherwise.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Magnets suitable for the present invention include industrial permanent magnets or any magnetic substance that produces a magnetic field. This magnetic field is invisible but is responsible for the most notable property of a magnet: a force that pulls on other ferromagnetic materials, such as iron, and attracts or repels other magnets. A permanent magnet is an object made from a material that is magnetized and creates its own persistent magnetic field. Materials that can be magnetized, which are also the ones that are strongly attracted to a magnet, are called ferromagnetic (or ferromagnetic). These include the elements iron, nickel and cobalt, some alloys of rare-earth metals, and some naturally occurring minerals such as lodestone.

Permanent magnets are made from “hard” ferromagnetic materials such as alnico and ferrite that are subjected to special processing in a strong magnetic field during manufacture to align their internal microcrystalline structure, making them very hard to demagnetize. Metals are ferromagnetic when found in their natural states, as ores. These include iron ore (magnetite or lodestone), cobalt and nickel, as well as the rare earth metals gadolinium and dysprosium (when at a very low temperature).

Ceramic, or ferrite, magnets are made of a sintered composite of powdered iron oxide and barium/strontium carbonate ceramic and can be formed in various shapes. The resulting magnets are non-corroding but brittle, but may be impregnated in a polymer or held in a housing. Alnico magnets are made by casting or sintering a combination of aluminum, nickel and cobalt The ferrite magnets are made from iron oxide and Ba- or Sr-carbonate.

Injection-molded magnets are a composite of various types of resin and magnetic powders, allowing parts of complex shapes to be manufactured by injection molding.

Flexible magnets are composed of a high-coercivity ferromagnetic compound (usually ferric oxide) mixed with a plastic binder. This is extruded as a sheet and passed over a line of powerful cylindrical permanent magnets.

Rare earth (lanthanoid) are used in compact high-strength magnets. The most common types of rare-earth magnets are samarium-cobalt and neodymium-iron-boron (NIB) magnets. Magnets having a magnetic grade of from n35 to n52 are preferred and affordable.

A Mn—Al alloy has a higher saturation magnetization than the ferrite magnets. Neodymium-iron-boron (NIB) magnets are among the strongest.

An example of the present invention is provided by explaining the use in a conventional oven or a controlled vapor oven or a temperature controlled cabinet as illustrated in the figures typically used in the food industry for cooking or holding food at selected temperature and humidity having horizontal hinged doors pivoting upward for access to the contents. Propping the door open for an extended period of time can result in food drying out, cooling down and losing moisture, in addition to compromising the temperature and humidity of the food preparation apparatus. Conventional oven door positioning hinges used on food service ovens have mechanical positioning components such as springs, notches, and latches that wear down over time. The present invention provides a magnetic positioning hinge and holding means for releasibly and temporarily holding a panel or shelf door open at a selected position out of the way of the user accessing the unit.

It is understood that the magnetic positioning hinge of the present invention can be incorporated on various containers, appliances, ovens, and cabinets all of which use horizontal hinged doors or panels requiring upward pivotal movement and a method for holding the door open for access to items in the unit. The example provided in the present application is directed to an oven or heated or cooled cabinet incorporating one or more horizontal doors or panels which are lifter upward along a horizontal axis and retained by means for holding to access the items therein; however, the principal is applicable to other apparatus utilizing overhead horizontal hinges.

For example, the magnetic positioning hinge is suitable for use on a temperature controlled cabinet or oven comprising a left side 12, a right side 14, a top 16, a bottom panel 18, a front panel 20 and back panel 22. In the upper portion of the cabinet 10 is at least one front door 24, which has a handle or knob 26, and which pivots about horizontal hinges 28. Above the front door 24 is shown a control panel 30 a display 32 indicates various words and numbers to communicate with the person using the cabinet. Below the display 32 are buttons for controlling the program, the upper heater temperature, the lower heater temperature, and the cook time, respectively. A switch turns the cabinet on and off. A plurality of lights indicate when the upper heating element, lower heating element or elements there between are turned on and off. The cabinet 10 is supported on legs or rubber feet.

The front door or panel 24 is hinged to the cabinet 10 frame by a horizontal magnetic positioning hinge 50 at the front of the cabinet 10 for pivoting about an overhead horizontal axis. The front door 24 pivots from a horizontal, raised position to a lowered position. A pin 36 extends through a segmented tube or sleeve 38 forming a knuckle 37 extending from a pair of plates or leafs having an upper portion or plate attaching to the cabinet frame and a lower portion of plate attaching to the front frame 20 permitting the pin 36 to rotate or hinge to rotate thereabout as the front door 24 pivots.

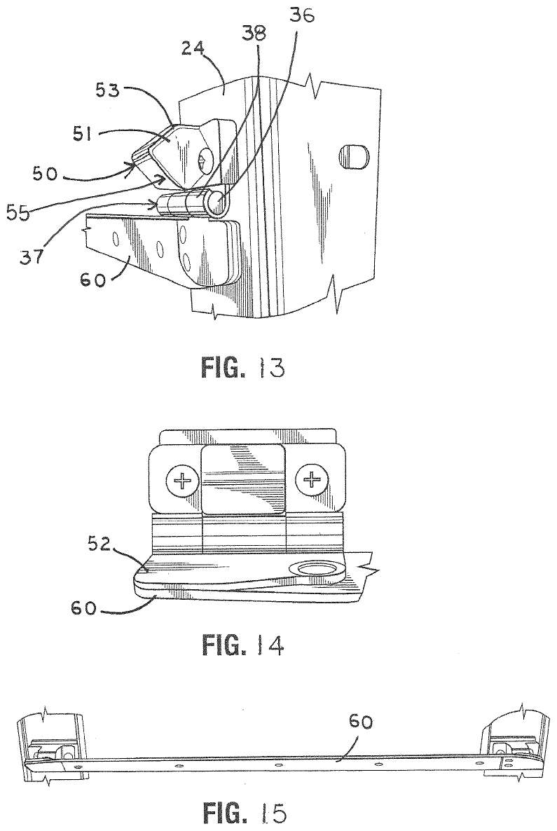

As illustrated in figures, the cabinet shows a pair of horizontally hinged overhead doors for accessing a top and bottom shelf including upper and lower front doors and a control panel for the cabinet. Of course it is contemplated that a single horizontal hinge could be utilized depending upon the length of the hinge. The cabinet door frame has a top and bottom door in the example shows a pair of spaced apart magnetic positioning members mounting to the top portion of each cabinet frame hinge for engagement with an adjacent opposing metal or magnetic strip attached to the door hinge. The magnetic cabinet hinge assembly utilizes an integrated magnetic positioner or catch to hold a door open at a set position or angle. The magnetic positioner can be mounted to an upper plate or leaf of the hinge which is mounted to the frame or be formed integrally therewith with the magnetic positioner 55 attaching to the frame 20 as shown in FIG. 13.

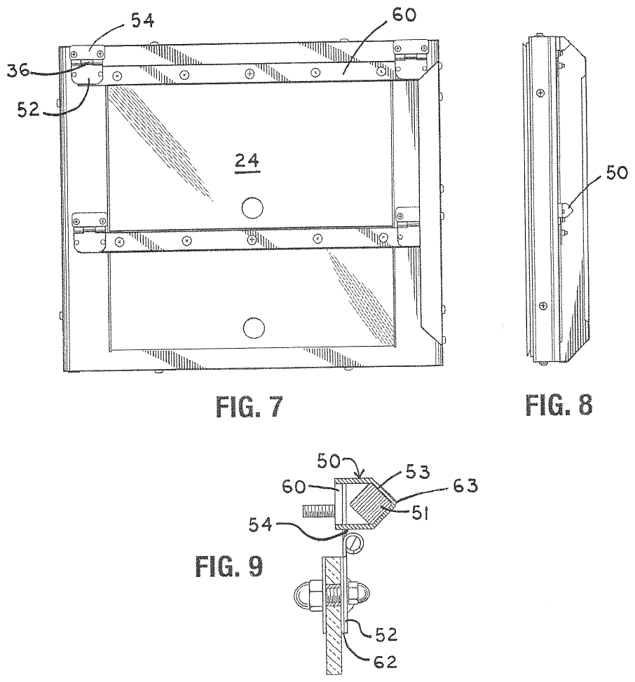

One preferred embodiment of the present invention utilities a pair of overhead horizontal hinges each one comprising a pair of aligned spaced apart hinge plates made of ferrous material, aluminum brass, or polymer, bent around a centerline forming a sleeves defining a knuckle to accept a pin. The surface of the door panel hinge plate 52 may be a ferrous or have a magnetic material or coating or contain a ferrous or magnetic material for cooperative engagement with the hinge plate or magnetic engaging material attached thereto and affixed to of the front panel 20. The pin is used to hold the two hinge plates 52, 54 together and acts as a pivot point for the knuckle 37. As shown in FIG. 7, the cabinet door frame includes a top and bottom overhead door showing a pair of spaced apart magnetic holding members mounting to the top portion of each cabinet frame hinges for engagement with an adjacent opposing metal or magnetic strip attached to the door hinge.

A magnetic positioning hinge assembly 50 includes the hinge plate 54 containing the magnet or magnetic material and positioning member 55 is attached to the front surface of the front frame 20 of the cabinet and the opposing hinge plate 52 is attached to the edge of the front door or panel 20 of the cabinet 10. The magnetic positioning wedge member 63 attaches to the outside surface of the hinge plate 54 attached to the frame 20 and permanent magnet, magnetic material, or polymer impregnated with a magnetic material 51. The magnet and/or positioning member may be covered by a coating, film or polymer 53 such as ABS or enclosed in a polymeric housing which does not interfere with the magnetic properties of the magnet. This positioning member is formed with a preset angle in mind that correlates with the degree that the door is to be opened and may be wedge shaped for cooperative engagement with the door which is pivoted to a predetermined angle to remain open when in use. When the door is opened and the metallic rotating ferrous hinge plate 52 of the door makes contact with the magnetic positioning hinge assembly 50, the magnetic attractive force removably attracts and holds the front door 24 with the front door panel hinge 52 open and abutting the magnetic positioning hinge assembly 50 attaching to the door hinge 54. The hinge allows for the easy and quick access to the cabinet.

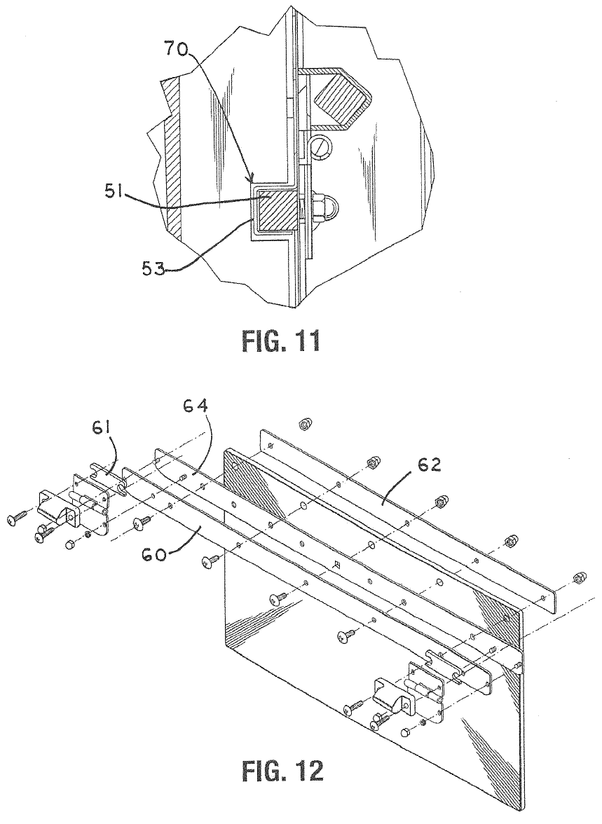

As shown in FIGS. 9 and 11, the door panel frame and hinge utilize a pair of metal hinge plates 52, 54 bent around a centerline forming segmented sleeves defining a knuckle to accept a pin 36. The pin 36 is used to hold the upper frame plate 60 and lower door plate 62 together and acts as a pivot point. Attached to the stationary upper frame plate 60 is the magnetic positioning hinge assembly 50 that houses a magnetic material such as neodymium magnet forming a magnetic member 51 disposed in a metal and or plastic housing 53 having a horizontal wedge formed at a preset angle that correlates with a selected degree that the door is to be held partially open whereby the rotating hinge allows the metal or magnetic surface of the door plate to contact the magnetic member so that the door plate rests against and is supported by the horizontal wedge portion 63 of the magnetic positioning hinge assembly 50 the magnetic force holds the door to the magnetic member open.

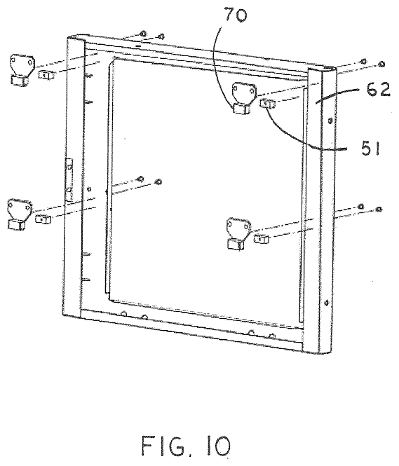

As shown in FIGS. 10 and 11, a magnet holding member positioning member 70 is attached on the inner surface of the panel frame 62 having a magnetic member 51 therein for contacting the door hinge plate wherein the magnet is mounted in a recess of the frame in magnetic communication with the door panel hinge plate aligned therewith on the opposing side of the door panel.

As best illustrated in the oven cabinet example, a first outer horizontal strip 60 mounting to the top of a door panel connects to a second intermediate strip 64 mounting on an opposing side of the door panel in alignment with the first outer horizontal strip and having an third inner panel strip 62 covering and mounting to the second intermediate strip, with a pair of magnetic positioning hinge assemblies 50 mounted to the outside of the first outer horizontal strip 60 having wedge shaped positioning members 63. A spacer 61 and a hinge assembly comprising a pair of pivoting hinge plates joined by a pin 36 and having a magnetic positioning member 51 comprising a plastic housing having a magnet disposed therein is affixed to the bottom portion of the hinge plate defining the cabinet door hinge plate.

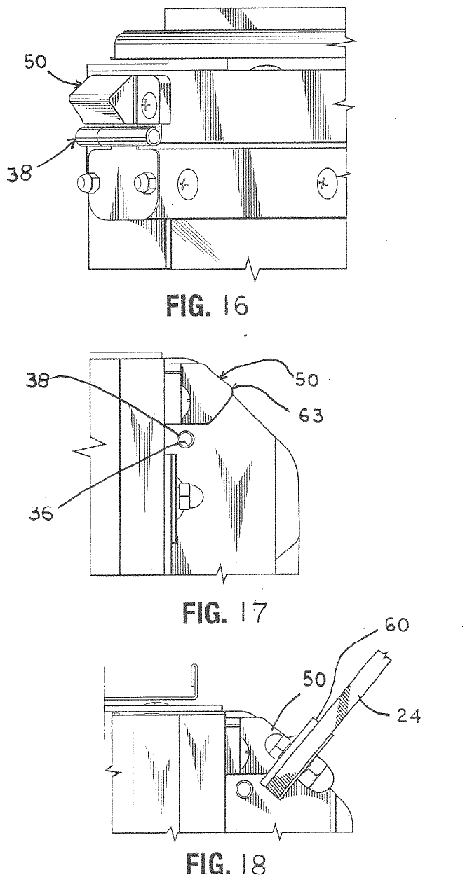

As illustrated in FIGS. 13-18, the pair of spaced apart magnetic holding members mount to the top portion of the cabinet frame hinge plate in cooperative engagement with an adjacent opposing metal or magnetic strip attached to the door hinge plate. The cabinet frame plate has a magnetic holding member attached thereto extending outwardly therefrom a selected distance and having an angled projecting surface for contacting the door hinge plate shown including an a magnet mounted in a recess of the frame in magnetic communication with the door hinge plate aligned therewith on the opposing side of the door panel.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

We claim:

1. A magnetic positioning hinge for a horizontal upward pivoting panel, comprising:
at least one pivotal horizontal hinge including an upper hinge plate and a lower hinge plate having adjacent edges bent around a centerline forming a segmented sleeve defining a knuckle for cooperatively receiving a pin;
said upper hinge plate attaching to a frame;
said bottom hinge plate attaching to a top portion of an overhead panel for pivotally connecting said overhead panel to said frame of a cabinet;
a positioning member attaching to said upper plate above said panel;
said positioning member including a housing having a magnet disposed therein for cooperatively engaging a magnet attractive material affixed to said panel, said housing of said positioning member formed having a selected angle for holding said panel open panel at a preset angle that correlates with a selected degree that said panel is to be held open when said positioning member is in cooperative engagement with a metal or a magnetic material affixed to said bottom hinge plate for releasably holding said panel open at a preset position.

2. The magnetic positioning hinge for a horizontal panel assembly of claim 1, further including at least one additional pivotal horizontal hinge spaced apart and in alignment with said at least one pivotal horizontal hinge.

3. The magnetic positioning hinge for a horizontal panel assembly of claim 1, wherein said selection of an angle for said positioning member provides means for setting an angle range of a set position for holding open said panel at any inner angle equal to or less than 180 degrees.

4. The magnetic positioning hinge for a horizontal panel assembly of claim 1, wherein said housing comprises a plastic for the magnet housing which does not shield the magnetic field of the magnet used in the hinge assembly.

5. The magnetic positioning hinge for a horizontal panel assembly of claim 1, wherein said housing is wedge shaped.

6. The magnetic positioning hinge for a horizontal panel assembly of claim 1, wherein said housing is attached to said upper plate.

7. The magnetic positioning hinge for a horizontal panel assembly of claim 1, wherein said housing and said upper plate are formed as an integral structure and said housing is attached to said frame.

8. The magnetic positioning hinge for a horizontal panel assembly of claim 1, wherein said panel comprises a window or a door.

9. The magnetic positioning hinge for a horizontal panel assembly of claim 1, further including a non-magnetic housing including a magnet therein.

10. The magnetic positioning hinge for a horizontal panel assembly of claim 1, wherein said housing comprises an ABS plastic material.

11. A magnetic positioning hinge for a horizontal panel assembly, comprising:
a cabinet including a left side, a right side, a top, a bottom panel, a front panel and back panel and at least one upward pivoting front panel including a pair of spaced apart aligned horizontal magnetic positioning hinges;
each one of said pair of horizontal magnetic positioning hinges comprising a pair of pivoting hinge plates including a top plate and a bottom plate joined by a pin, said top plate attaching to said front panel of said cabinet and having a housing having a magnet disposed therein, and said bottom plate including a metal or magnetic material attaching to a panel frame supporting said at least one upward pivoting front panel alignable with said housing of said top plate, whereby pivoting said at least one upward pivoting front panel upward until said bottom plate contacts said magnet positioning member releasably holds said upward pivoting front panel in an upward position.

12. The magnetic positioning hinge for a horizontal panel of claim 11, wherein said housing comprises a wedge shaped projection for holding an cabinet door at a selected angle.

13. The magnetic positioning hinge for a horizontal panel of claim 11, further including a magnetic metal bottom plate for cooperative magnetic engagement with said housing.

14. The magnetic positioning hinge for a horizontal panel of claim 11, wherein said panel comprises a door or a window.

15. The magnetic positioning hinge for a horizontal panel of claim 11, wherein said housing is a non-magnetic housing including a magnet therein.

16. The magnetic positioning hinge for a horizontal panel of claim 11, wherein said housing comprises an ABS plastic material.

17. The magnetic positioning hinge for a horizontal panel of claim 11, wherein said front door can be held open at an angle of up to 180 degrees.

18. The cabinet and magnetic positioning hinge for a horizontal panel of claim 11, further including a bottom plate having an opposing magnet for cooperative magnetic engagement with said housing.

19. The cabinet and magnetic positioning hinge for a horizontal panel of claim 11, wherein said cabinet is a convention cabinet.

20. The cabinet and magnetic positioning hinge for a horizontal panel of claim 11, wherein said cabinet is a controlled vapor cabinet.

21. The cabinet and magnetic positioning hinge for a horizontal panel of claim 11, wherein said wedge is formed at a selected preset angle correlating to a selected degree the front door is held open upon said magnet or magnetic material of said bottom plate contacts said wedge containing said magnet.

22. The cabinet and magnetic positioning hinge for a horizontal panel of claim 11, wherein said wedge is formed of a selected size and shape to cooperatively engage said magnetic metal or magnetic material and releasably hold said front door open at a selected angle.

23. The cabinet and magnetic positioning hinge for a horizontal panel of claim 11, wherein said housing and said upper plate are formed as an integral structure and said housing is attached to said frame.

24. A container having a magnetic positioning hinge for a horizontal panel assembly, comprising:
a container including a left side, a right side, a top, a bottom panel, a front panel and back panel and at least one pivoting front panel including a pair of spaced apart aligned horizontal magnetic positioning hinges;
each one of said pair of horizontal magnetic positioning hinges comprising a pair of pivoting hinge plates including a top plate and a bottom plate joined by a pin, said top plate attaching to said front panel of said container and having magnetic positioning member and said bottom plate including a metal or magnetic material attaching to said panel frame supporting said at least one front panel alignable with said magnetic positioning member of said top plate, whereby pivoting said front panel upward until said bottom plate contacts said magnetic positioning member releasably holds said front panel in an upward position at a pres-selected angle.

25. A container having a magnetic positioning hinge for a horizontal panel assembly of claim 24, wherein said panel comprises a window or a door.

26. The container having a magnetic positioning hinge for a horizontal panel assembly of claim 24, wherein said housing comprises a wedge shaped projection for holding said panel at a selected angle.

27. The container having a magnetic positioning hinge for a horizontal panel assembly of claim 24, further including a magnetic metal bottom plate for cooperative magnetic engagement with said housing.

28. The container having a magnetic positioning hinge for a horizontal panel assembly of claim 24, further including a non-magnetic housing including a magnet therein.

29. The container having a magnetic positioning hinge for a horizontal panel assembly of claim 24, wherein said housing comprises an ABS plastic material.

30. The container having a magnetic positioning hinge for a horizontal panel assembly of claim 24, wherein said front panel can be held open at an angle of up to 180 degrees.

31. The container having a magnetic positioning hinge for a horizontal panel assembly of claim 24, further including a bottom plate having an opposing magnet for cooperative magnetic engagement with said housing.

32. The container having a magnetic positioning hinge for a horizontal panel assembly of claim 24, wherein said container is a convention oven.

33. The container having a magnetic positioning hinge for a horizontal panel assembly of claim 24, wherein said oven is a controlled vapor oven.

34. The container having a magnetic positioning hinge for a horizontal panel assembly of claim 24, wherein said magnetic positioning member and said upper hinge are formed as an integral member for attachment to said frame.

35. The container having a magnetic positioning hinge for a horizontal panel assembly of claim 24, wherein said magnetic positioning member is a wedge formed at a selected preset angle correlating to a selected degree the front panel is held open upon said magnet or magnetic material of said bottom plate contacts said wedge containing said magnet.

36. The container having a magnetic positioning hinge for a horizontal panel assembly of claim 24, wherein said magnetic positioning member is a wedge formed of a selected size and shape to cooperatively engage said magnetic metal or magnetic material and releasably hold said front panel open at a selected angle.
